(19) United States
(12) Patent Application Publication
(10) Pub. No.: US 2007/0282995 A1
(43) Pub. Date: Dec. 6, 2007

(54) MANAGEMENT SYSTEM, CONTROL METHOD THEREFOR, AND COMPUTER PROGRAM

(76) Inventors: Atsushi Mizuno, Yokohama-shi (JP); Yasuhiro Hosoda, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/734,978

(22) Filed: Apr. 13, 2007

(30) Foreign Application Priority Data
Apr. 17, 2006 (JP) 2006-113749

(51) Int. Cl. G06F 15/173; G06F 21/20

(52) U.S. Cl. 709/223; 709/225

(57) ABSTRACT

A plurality of device groups are layered and displayed on a display unit based on management information for grouping a plurality of image processing devices and managing them as a device group having a layer attribute. Setting of function restriction information on a function restricted in use in executing a job is accepted for the device group selected from the device groups. The function restriction information is set for all image processing devices in the set device group. At this time, the set function restriction information is set for a group of image processing devices on a lower layer of the selected device group.

### BACKGROUND OF THE INVENTION

1. Field of the Invention

The present invention relates to a management system, a control method therefor, and a computer program.

2. Description of the Related Art

Recently, computer networks (to be simply referred to as networks hereinafter) which connect computers to each other have gained in popularity. A network can be constructed for a floor of a building, for an entire building, within multiple buildings (in a local area), for a region, or for a wide area. Such networks further connect to each other to form a global network, that is, the so-called “Internet”.

On a network, computer peripheral devices (printing apparatuses) such as printers, facsimile machines, and copying machines are often connected in addition to computers, and are available from computers via the network. Printing via the network (network printing) has recently become popular because of its advantages: a plurality of computers can share a large-scale high-speed printer or an expensive color printer and can print from remote locations.

Recent copying machines not only document copying functions, but also allow submission of print jobs from external clients, as well as electronic transmission of scanned documents outside the copying machine using an e-mail or file transfer function. Such copying machines are called an MFP (Multi Function Peripheral).

External transmission of scanned information using the multiple functions of MFP can pose well-known security problems such as a high information leakage risk. As the number of pages printed increases, the cost of paper and toner consumables also rises. There is a need to restrict printing functions and limit the printable sheet count for each user. This is important in terms of TCO (Total Cost of Ownership) reduction.

Several solutions have already been proposed to address these problems. As prior art, Japanese Patent Laid-Open No. 11-134136 proposes a method of managing each user by his ID, and restricting available functions, resources, and the amount of time for each ID.

In a conventional system, a system administrator generally sets restriction information for each user. The system manages and uses the restriction information by storing data (FIG. 18) in table form. Per-user restriction information is called an access control list (to be referred to as an ACL hereinafter). In FIG. 18, permitted functions and prohibited functions are managed for each user (user A, B. C, or D) in table form. For example, functions 1 to 3 are permitted for user A, whereas only function 1 is permitted for user D.

Although restrictions can be made for each user, the system administrator may want to place restrictions on and make settings for each device instead of providing per-user settings. In other words, the system administrator tries to restrict and set device functions common to users, regardless of individual user identity.

In this case, it is cumbersome to set the ACLs of respective users as shown in FIG. 18 for each device and change ACL settings of all users for each device. The result is an increase in system management cost and a hindrance to the system goal of a reduction in TCO.

### SUMMARY OF THE INVENTION

It is an object of the present invention to provide a mechanism allowing a system administrator of a network device or the like to easily perform function restriction settings and the like for a device.

According to one aspect to solve the above problems, the present invention relates to a management system connected via a network to a plurality of image processing devices and a client apparatus, comprising, a storage unit adapted to store management information for grouping the plurality of image processing devices and managing the plurality of image processing devices as a device group having a layer attribute, a display controller adapted to layer a plurality of device groups based on the management information and causes a display unit to display the layered device groups, a selection unit adapted to select a device group from the layered device groups displayed on the display unit, a setting acceptance unit adapted to accept, for the device group selected by the selection unit, setting of function restriction information on a function restricted in use in executing a job, and a setting unit which sets the function restriction information for all image processing devices in the set device group, wherein the setting unit sets, for a group of image processing devices on a lower layer of the selected device group, the function restriction information set by the setting unit.

According to another aspect to solve the above problems, the present invention relates to a management system which has an authentication unit adapted to perform authentication for a request from an external apparatus, and a response unit adapted to send back a response associated with function restriction in job execution to an authentication requesting side based on the authentication by the authentication unit, and which can communicate with a plurality of image processing devices, comprising, a grouping unit adapted to set a group of image processing devices, a setting indication unit adapted to indicate function restriction setting of an image processing device, and a setting unit which makes the function restriction setting indicated by the setting indication unit at once for the image processing devices grouped by the grouping unit, wherein when one of the grouped image processing devices issues the request, the response unit sends back a response associated with function restriction with reference to contents set by the setting unit.

According to still another aspect to solve the above problems, the present invention relates to a management system comprising, a grouping unit adapted to set a group of image processing devices, a setting indication unit adapted to indicate function restriction setting associated with a function of an image processing device that is restricted in use in executing a job by the image processing device, and a setting unit adapted to make the function restriction setting indicated by the setting indication unit at once for the image processing devices grouped by the grouping unit.

Further features of the present invention will become apparent from the following description of exemplary embodiments (with reference to the attached drawings.).

### BRIEF DESCRIPTION OF THE DRAWINGS

FIG. 1 is a class view showing an example of the logical configuration of an overall system according to embodiments of the present invention;

FIG. 2 is a view showing an example of the layout of functional elements in the system according to embodiments of the present invention;

FIG. 3 is a block diagram showing an example of the internal arrangement of a server PC or client PC according to embodiments of the present invention;

FIG. 4 is an operation sequence chart showing an outline of the operation of the overall system according to embodiments of the present invention;

FIG. 5A is a table showing an example of the data structure of an ACL for each user according to embodiments of the present invention;

FIG. 5B is a table showing an example of the data structure of an ACL for each device according to embodiments of the present invention;

FIG. 5C is a view showing an example of the data structure of an ACT according to embodiments of the present invention;

FIG. 6 is a view showing print job data as an example of a job format according to embodiments of the present invention;

FIG. 7 is a flowchart showing an example of a device management table creation operation according to the first embodiment of the present invention;

FIG. 8 is a flowchart showing an example of a device group setting operation according to the first embodiment of the present invention;

FIG. 9 is a view showing a display example of a device group management window according to the first embodiment of the present invention;

FIG. 10 is a view showing an example of a function restriction information setup/editing window for a device group according to the first embodiment of the present invention;

FIG. 11 is a table showing an example of the data structure of an ACL according to the second embodiment of the present invention;

FIG. 12 is a flowchart showing an example of a device group moving process according to the fourth embodiment of the present invention;

FIG. 13 is a view showing an example of a display window according to the fourth embodiment of the present invention;

FIG. 14 is a view showing an example of a display window according to the fourth embodiment of the present invention;

FIG. 15 is a view showing an example of a display window according to the fourth embodiment of the present invention;

FIG. 16 is a view showing an example of a display window according to the fourth embodiment of the present invention;

FIG. 17 is a view showing an example of a display window according to the fourth embodiment of the present invention; and

FIG. 18 is a table showing a conventional ACL.

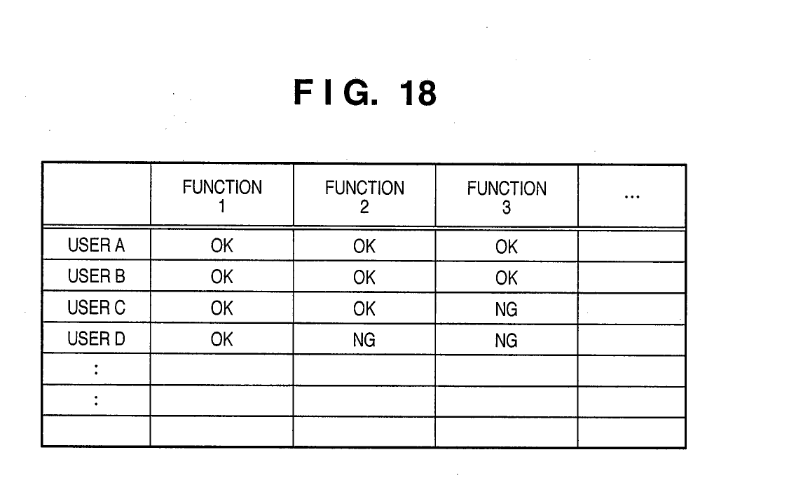

### DESCRIPTION OF THE EMBODIMENTS

Preferred embodiments of the present invention will be described below with reference to the accompanying drawings.

### First Embodiment

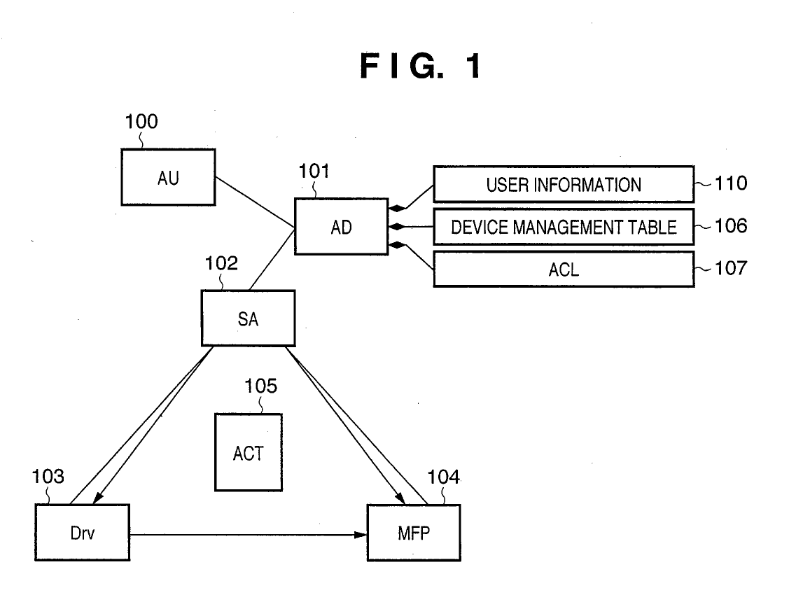

FIG. 1 is a class view showing an example of the logical configuration of an overall system according to the present invention. The class view of FIG. 1 is described in UML (Universal Modeling Language) notation. The class view of FIG. 1 is applicable to, for example, a system formed from a device, server PC, and client PC connected on a network. More specifically, this system can be built as a print management system which performs access restriction and job execution restriction (e.g., print count) on a user who uses a device. The term “user” is used under the concept of identifying a user including an individual user, division, or organization.

A system administrator utility (AU) 100 runs on a server PC (not shown), and sets and manages the system. In particular, the AU 100 can perform settings of function restriction information on a user information server (AD) 101.

The AD 101 stores and manages user information 110 such as a user ID and password to identify a user. A device management table 106 stores and manages management information on each device or each group of devices in the system. As management information, the device management table 106 also stores and manages a layer attribute corresponding to each device group. The AD 101 stores and manages function restriction information (to be referred to as “ACL” hereinafter) 107 representing which functions are available for each user or device in the system. The AD 101 is formed from an LDAP (Lightweight Directory Access Protocol) server, Active Directory server, or the like. The ACL 107 will be described in more detail later.

A ticket issuing server (SA) 102 issues a ticket describing information regarding available functions based on the ACL 107 stored in the AD 101. The ticket is called an access control token (to be referred to as an “ACT” hereinafter). The ACT is data which describes access restriction information on a user and function restriction on a device, and transfers these pieces of information from a server to a device. The requesting side is authenticated in issuing a ticket, and an electronic signature is also issued to prove that the requesting side is an authentic user or device. This authentication can be achieved based on whether a requesting user or device is registered in the user information 110, device management table 106, or ACL 107 in the AD 101. The ACT will be sometimes called function restriction information in the sense that the ACT restricts functions, or permission information in the sense that the ACT represents which function is available.

A printer driver (Drv) 103 runs on a client PC (not shown). When the user uses the client PC, he must log in to identify himself as a particular user using it. The user ID and password used in login should correspond to the user information 110.

A device 104 is especially a multifunction peripheral (MFP) serving as an image processing device. The image processing device can be a laser beam printer, inkjet printer, or the like having no document scan function. In the following description, the MFP will be exemplified. The MFP 104 can have the following functions in addition to a function of copying a paper document. For example, the MFP 104 can have a function of printing data sent from the printer driver of an external apparatus such as a personal computer connected via a network. The MFP 104 can also have functions (send function and remote scan function) of scanning a paper document in the MFP 104 to generate image data, and sending the image data to an external file server or mail address. The MFP 104 can further have a function (remote copy function) of sending, to another MFP, image data generated by scanning a paper document in the MFP 104, and causing the destination MFP to print the image data.

An access control token (ACT) 105 is utilized as a ticket describing information on functions executable by the user with the MFP 104 and function restriction information of the MFP 104.

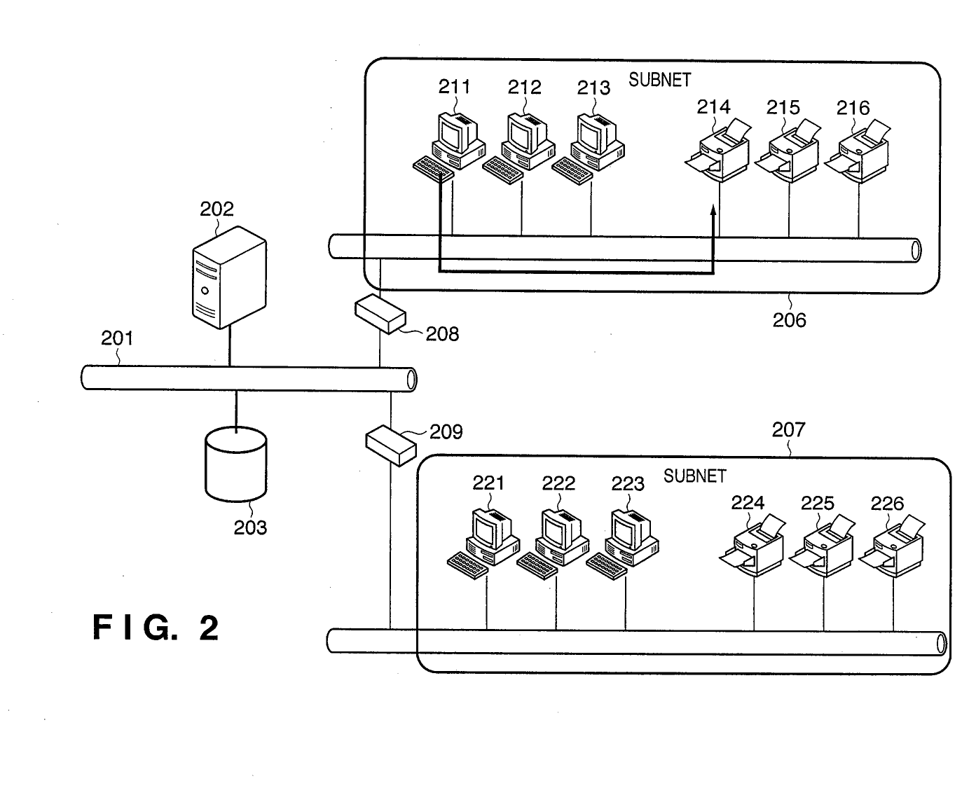

FIG. 2 is a view showing an example of the layout of functional elements in the system shown in FIG. 1.

A network 201 is connected to terminals according to the first embodiment. Apparatuses communicably connect to each other via the network 201. In general, connection via Ethernet® or the like provides services to a somewhat local user group such as a user group on a floor or consecutive floors of a building. A wide area network (WAN) may also be established as a user moves apart from the remaining users, for example, moves to another building or region.

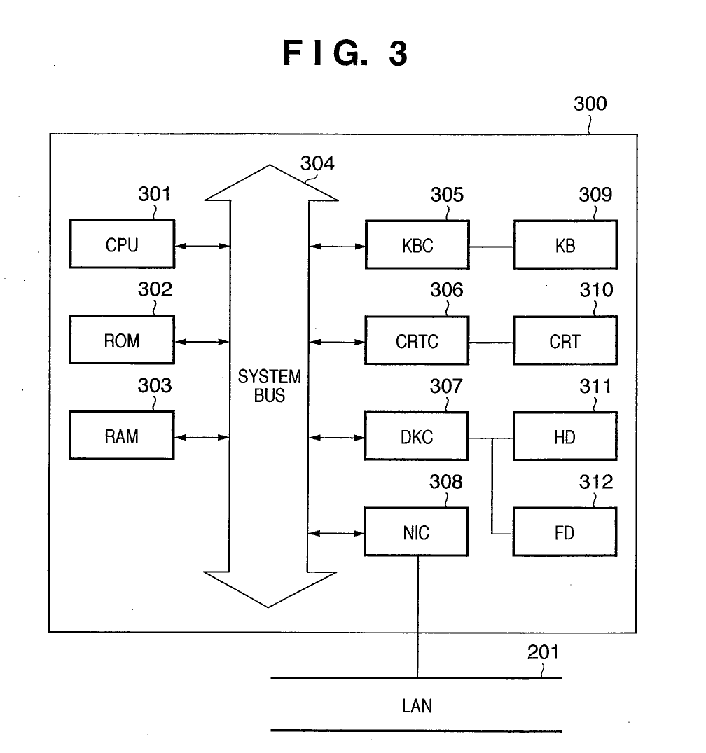

A server PC 202 connects to the network 201. The AU 100 and SA 102 in FIG. 1 run on the server PC 202. The server PC 202 is configured by an OS such as Microsoft Windows® or UNIX, a computer compatible with the OS, an application program for implementing the management function, and the like. The detailed arrangement of the server PC 202 will be described with reference to FIG. 3. The AD 101 in FIG. 1 runs on a directory server 203. The directory server 203 holds the ACL 107 and user information 110.

In FIG. 2, the AU 100 and SA 102 run on the server PC 202, whereas the AD 101 runs on the directory server 203. However, the embodiments of the present invention are not limited to this configuration. For example, the AU 100, AD 101, and SA 102 may individually run on different server PCs connected to the network 201. Alternatively, the AU 100, AD 101, and SA 102 may run on a single server connected to the network 201. The functions of the AU 100, AD 101, and SA 102 can be arbitrarily built in an arbitrary number of apparatuses. For example, the user may also install some or all of the functions of the AU 100, AD 101, and SA 102 in a client PC.

The network 201 includes subnets 206 and 207, routers 208 and 209 which control network packets to form the subnets, and client PCs 211 to 213 and 221 to 223. The client PC 211 and the like are computers compatible with an OS such as Microsoft Windows® or UNIX. The Drv 103 in FIG. 1 runs on each client PC. Copying machines 214 to 216 and 224 to 226 each correspond to the MFP 104 in FIG. 1.

FIG. 2 is a view showing merely an example of the system. The SA 102 and Drv 103 other than the MFP 104 in FIG. 1 may be implemented by the client PC 211 or the like or by several server PCs. The interface between the Drv 103 and the SA 102 and that between the SA 102 and the AD 101 may be physical communication media such as a network, local interface, or CPU bus. These interfaces may also be software logical interfaces for message communication. Each functional block described above may execute each function by executing a program by the CPU or may be mounted as a hardware circuit.

FIG. 3 is a block diagram showing an example of the hardware configuration of the server PC 202 or the client PC 211 or the like.

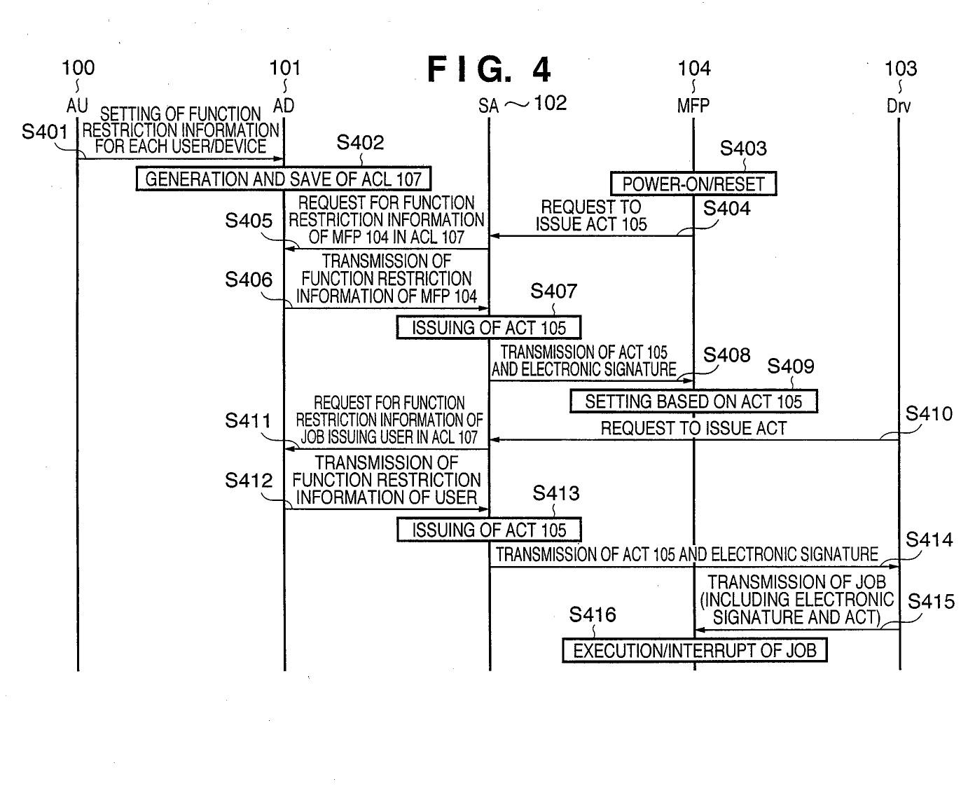

In a PC 300, a CPU 301 comprehensively controls devices connected to a system bus 304. The CPU 301 can implement the functions of the AU 100, SA 102, and Drv 103 based on a program stored in a ROM 302 or hard disk (HD) 311 or supplied from a floppy® disk drive (FD) 312. The CPU 301 also functions as a main processor for processes according to the flowcharts of FIGS. 4, 7, 8, and 12 to be described later, and achieves these processes by executing corresponding process programs.

A RAM 303 functions as a main memory, work area, and the like for the CPU 301. A keyboard controller (KBC) 305 controls an indication input from a keyboard (KB) 309 or a pointing device (not shown). A CRT controller (CRTC) 306 controls display on a CRT display (CRT) 310. A disk controller (DKC) 307 controls access to the hard disk (HD) 311 and floppy® disk (FD) 312 which store a boot program, various applications, edit files, user files, and the like. A network interface card (NIC) 308 bidirectionally exchanges data with each printing apparatus and each print control apparatus via the network 201.

The user interface of the server PC 202 can be a Web interface using HTTP/HTML or the like, in addition to devices such as the KB 309 and CRT 310 physically connected to the server. An administrator's computer (not shown) connected to the network 201 can operate the server PC 202 via the network 201.

An outline of the operation of the overall system shown in FIG. 1 will be explained with reference to the operation sequence in FIG. 4.

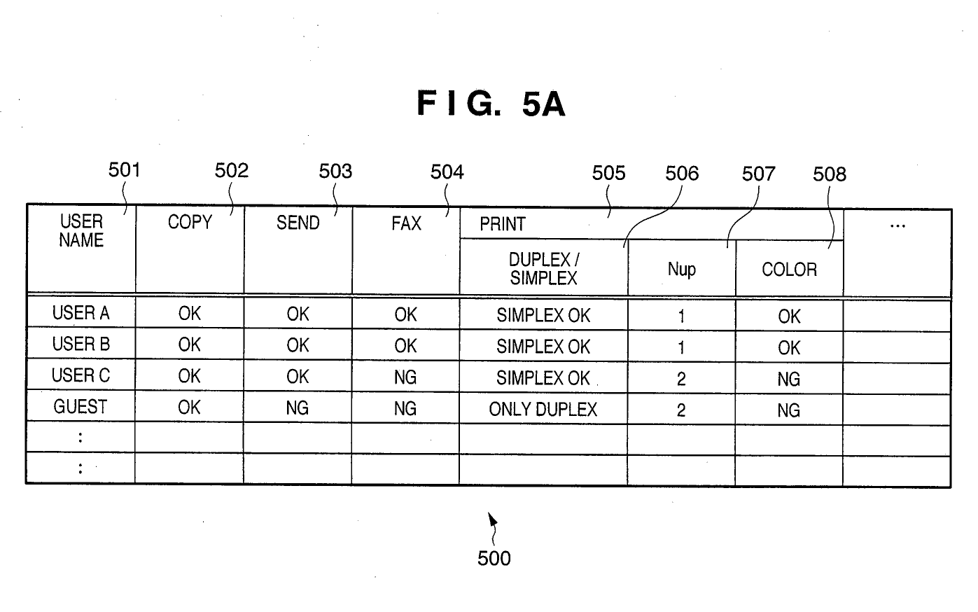

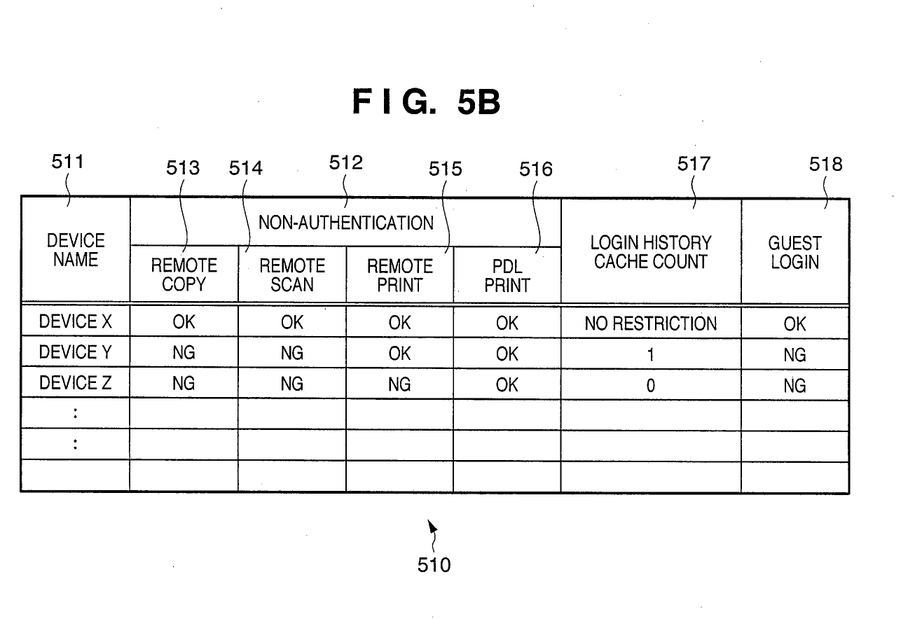

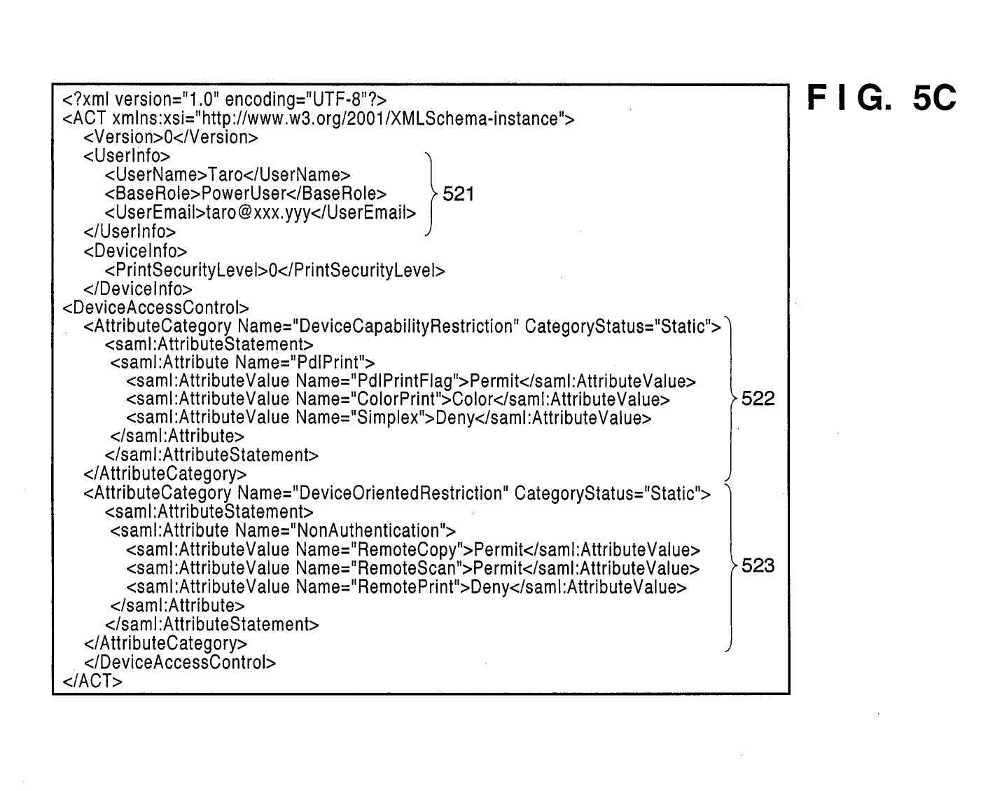

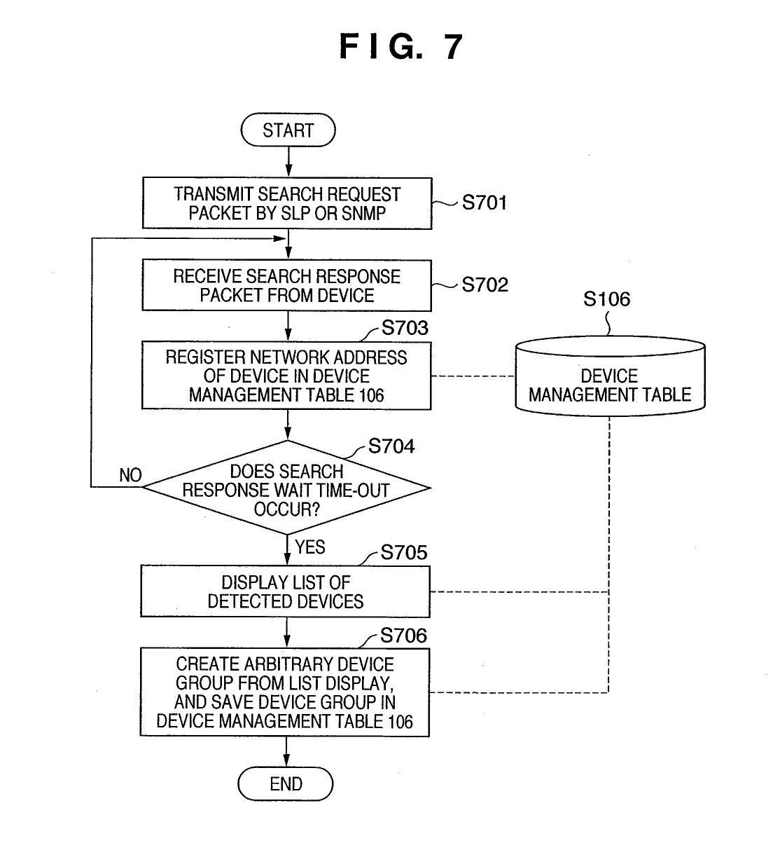

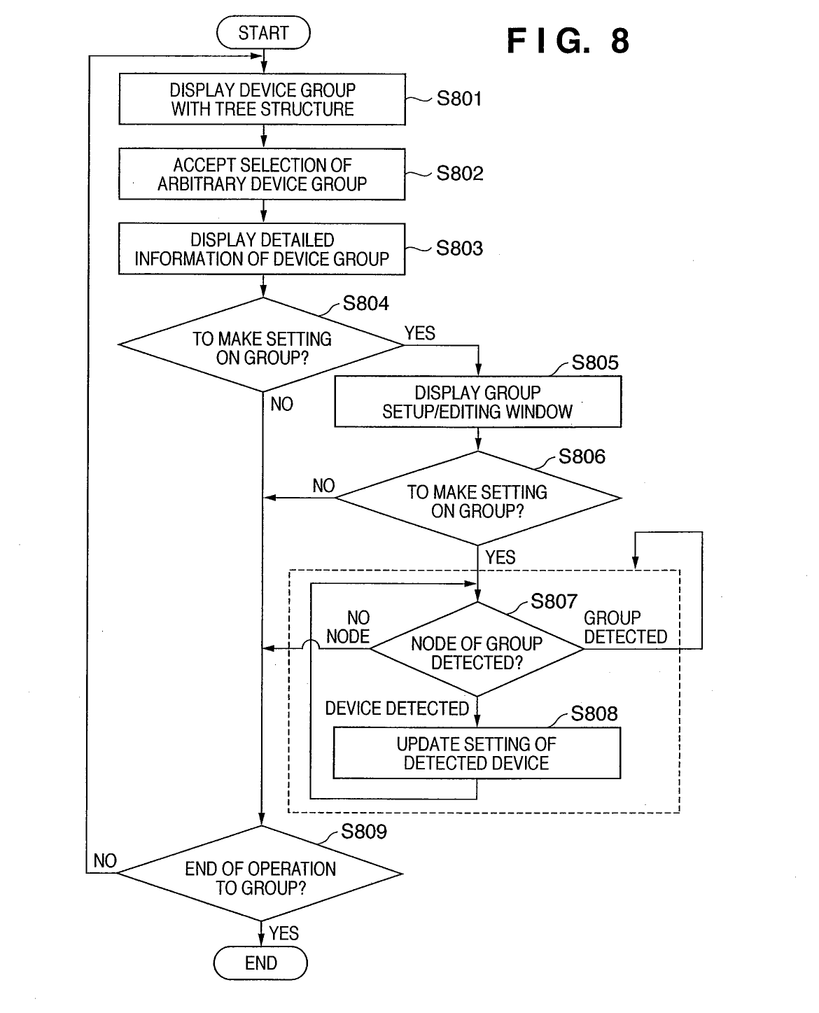

In step S401, the AU 100 sets function restriction information of each user or device in the AD 101. In step S402, the AD 101 saves the ACL 107 in it. In FIG. 4, step S401 is executed first. Once settings are made, step S401 is expected to be executed at an arbitrary timing. Details of the ACL 107 will be described later with reference to FIGS. 5A and 5B. Setting, editing, update, and deletion of the ACL 107 for each device will be described later with reference to the flowcharts of FIGS. 7 and 8.

In step S403, the MFP 104 is turned on or reset. in step S404, along with the activation process, the MFP 104 requests the SA 102 to issue an ACT describing function restriction information of the MFP 104. The ACT issuing request contains an identifier (for example, an IP address, MAC address, or image processing device name) capable of specifying an image processing device. The ACT 105 is function restriction information of the MFP 104 associated with job execution, and may be acquired from the SA 102 when the Drv 103 requests job execution. Processes based on steps S403 to S409 may be executed when detecting input of, e.g., an indication to copy via the operation unit of the image processing device regardless of whether the user logs in to the MFP 104.

The SA 102 extracts the identifier which is contained in the issuing request of the ACT 105 from the MFP 104 and specifies an image processing device, and requests function restriction information based on the extracted identifier of the AD 101. More specifically, when receiving an ACT issuing request from an external apparatus, the SA 102 requests function restriction information of the MFP 104 in the ACL 107 stored in the AD 101, based on the identifier contained in the ACT request in step S405. The AD 101 causes its authentication unit to perform authentication in accordance with the request containing the identifier of the ACT issuing side from the SA 102. If the AD 101 confirms that the ACT issuing side has already been registered and is authentic, it acquires function restriction information based on the identifier from a management unit. In step S406, the AD 101 transmits the function restriction information of the MFP 104 to the SA 102. In step S407, the SA 102 issues the ACT 105 based on function restriction information which is transmitted from the AD 101 and means job execution permission information. Details of the ACT 105 will be described later with reference to FIG. 5C. Also at this time, the SA 102 generates an electronic signature to prove that the SA 102 issues the ACT 105. In step S408, the SA 102 sends back the issued ACT 105 and electronic signature to the MFP 104.

Function restriction information (ACL 107) of the MFP can be set at once for a predetermined device group by flowcharts to be described later. At this time, if the SA 102 receives the issuing request of the ACT 105 from the MFP 104, it sends back function restriction which is contained in the ACT 105 and set at once based on the latest updated settings for a device group to which the requesting MFP 104 belongs.

In step S409, the MFP 104 makes initial settings in the MFP 104 based on the contents of the function restriction information described in the acquired ACT 105. More specifically, the ACT 105 contains descriptions:

permission/inhibition of remote copy without user authentication information

permission/inhibition of remote scan without user authentication information

permission/inhibition of remote print without user authentication information

permission/inhibition of PDL print without user authentication information

### Based on these descriptions, the MFP 104 sets whether to continue the process of a job when receiving the job.

The ACT 105 also contains a description:

login history cache count

### Based on this description, the MFP 104 sets how many login histories are left in the login window of the MFP 104. This is a function of reducing resources used in the MFP 104.

The ACT 105 also contains a description:

permission/inhibition of

guest login of an unregistered user Based on this description, the MFP 104 sets whether to display a guest login button in the login window of the MFP 104.

A case in which the Drv 103 issues a job to the MFP 104 will be explained. Before issuing a print job to the MFP 104, the Drv 103 requests the SA 102 in step S410 to issue the ACT 105 (function restriction information) of a user who is to issue a job. Requested function restriction information (ACT 105) of the user is discriminated from function restriction information of the MFP 104 described in step S405.

If the external apparatus requests the SA 102 to issue an ACT, the SA 102 requests function restriction information contained in the ACL 107 stored in the AD 101 in correspondence with the user who is to issue a job, based on an identifier contained in the ACT issuing request in step S411. The AD 101 causes its authentication unit to perform authentication in accordance with the request containing the identifier of the ACT issuing side from the SA 102. If the AD 101 confirms that the ACT issuing side has already been registered and is authentic, it acquires function restriction information based on the identifier from the management unit. In step S412, the AD 101 transmits the function restriction information of the user to the SA 102. In step S413, the SA 102 issues the ACT 105 based on function restriction information which is transmitted from the AD 101 and means job execution permission information. Also at this time, the SA 102 generates an electronic signature to prove that the SA 102 issues the ACT 105. In step S414, the SA 102 sends back the issued ACT 105 and electronic signature to the Drv 103.

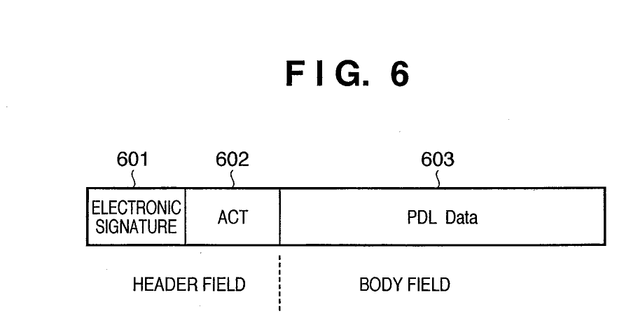

The Drv 103 generates a print job using the received ACT 105, and transmits the generated print job to the MFP 104 in step S415. The ACT 105 acquired from the SA 102 is added to header information of the print job. FIG. 6 shows an example of the format of this print job.

In FIG. 6, a print job 600 contains an electronic signature 601 representing that the job is based on an issuing request from an authentic user, an ACT 602, and a body field 603 representing work contents requested of the MFP 104. FIG. 6 shows an example of a job which requests printing of data contained in the body field. The ACT 602 in FIG. 6 corresponds to the ACT 105 received by the Drv 103 from the SA 102.

Upon reception of the print job 600, the MFP 104 determines in step S416 whether to execute or interrupt the job, and performs an operation based on the determination result. More specifically, the MFP 104 determines whether authentication has been executed, based on whether the job acquired in step S408 contains the electronic signature 601. If authentication has been executed, the MFP 104 determines whether to execute the job, based on function restriction information described in the ACT 602 of the print job 600 and the request contents of the job. If no authentication has been executed, the MFP 104 determines whether to execute the job, based on details of function restriction information described in the ACT of the MFP 104 and the request contents of the job.

A concrete example of the ACL 107 will be explained with reference to FIGS. 5A and 5B. The ACL 107 is formed from two ACLs as shown in FIGS. 5A and 5B. FIG. 5A shows the first ACL describing function restriction information of each user who uses a device. FIG. 5B shows the next ACL describing, for each device, function restriction information of the device such as the MFP 104.

As shown in FIG. 5A, an ACL 500 contains the items of a user name 501, copy 502, send 503, FAX 504, and print 505. The print 505 contains more detailed setting items of duplex/simplex 506, Nup 507, and color 508. The ACL in FIG. 5A is common to a plurality of MFPs 104, but the ACL of each user may be set for each MFP.

The user name 501 registers information for identifying a user who uses the device. The user name 501 may be a user ID in the user information 110. When a guest can log in to the system, the user name 501 can use function restriction information of “guest”. The copy 502 registers restriction information on a function of printing data scanned by the MFP, 104. “OK” in the copy 502 means permission of the use of the function, and “NG” means inhibition of the use of the function. This also applies to the following description, unless otherwise specified. The send 503 registers restriction information on a function of scanning a paper document by the device to generate image data, and transmitting the image data to an external file server or mail address.

The FAX 504 registers restriction information on the facsimile function. In the print 505, the duplex/simplex 506 registers restriction information on the duplex/simplex printing function. For example, there are three pieces of restriction information “simplex OK”, “only duplex”, and “only simplex”. “Simplex OK” means that printing is possible on one or two surfaces.

The Nup 507 is so-called “Nin1” setting, and registers restriction information representing the number of document pages which can be laid out on one print page. For example, when the Nup 507 is “2”, two document pages to be printed can be laid out on one print page. When the Nup 507 is “1”, a plurality of document pages to be printed cannot be laid out on one print page.

The color 508 registers restriction information representing whether color printing is possible. “OK” in the color 508 means permitting color printing, and “NG” means inhibiting color printing and permitting only monochrome printing.

The ACL of each device shown in FIG. 5B will be explained. An ACL 510 contains the item of a device name 511, and that of non-authentication 512 including the items of remote copy 513, remote scan 514, remote print 515, and PDL print 516. Further, the ACL 510 contains the items of a login history cache count 517 and guest login 518. The function of posing restriction for each device is not limited to the above-described ones, and various functions are applicable.

The device name registers information for identifying each device. The device name 511 may be a name assigned to each device, the name of a device, a MAC address, or an IP address as long as the device name 511 is information capable of uniquely identifying each device.

The item of the non-authentication 512 defines restriction information when a job transmitted from the MFP 104 serving as a device does not contain either the electronic signature or ACT 105 serving as authentication information. For example, the print job 600 shown in FIG. 6 contains the electronic signature 601 and ACT 602 as authentication information, so the item of the non-authentication 512 is invalid. When a job having non-authentication information is received, whether to execute a requested job is determined based on each restriction information in the item of the non-authentication 512.

The remote copy 513 registers restriction information on a function of transmitting data scanned by one MFP 104 to another MFP and printing it. “OK” in the remote copy 513 means permitting the use of the function, and “NG” means inhibiting the use of the function. This also applies to the following description, unless otherwise specified. For example, there is an old type MFP or the like which does not assume a print job of the format shown in FIG. 6. When the old type MFP performs remote copy, another MFP receives scanned data having no restriction information as shown in FIG. 6. This situation occurs regardless of whether another MFP is compatible with the format in FIG. 6. The first embodiment assumes this situation and adopts the ACL of each device as shown in FIG. 5B.

The remote scan 514 registers restriction information on a function of acquiring scanned data by the client PC 211 or the like on the network 201 using the scanner of the MFP 104. The remote print 515 registers restriction information on a function of printing data transmitted via the network by a protocol (e.g., FTP) other than a general printing system protocol (e.g., LPR). The PDL print 516 registers restriction information on a function of printing data transmitted via the network by a general printing system protocol.

The login history cache count 517 registers the number of logs to be held as restriction information when leaving user input information as a history. For example, when “no restriction” is set, all pieces of history information on input users are saved. When “1” is set, history information of only one past user is saved.

The guest login 518 saves restriction information representing whether to allow a user not registered in the system, that is, a user whose user information 110 is not managed in the AD 101, to use a device as a guest user. In the first embodiment, an unregistered user can sometimes use the MFP 104 by logging in as a guest user to the system using a user ID and password given to the guest. When the guest login 518 represents “OK”, guest login is permitted. By acquiring authentication information, the guest user can use device functions in accordance with the contents of the ACT 105 in the authentication information. When the guest login 518 represents “NG”, guest login is inhibited. Even if the guest user acquires authentication information, he is restricted in the use of functions based on function restriction information of each device. For example, for device Y, guest login is inhibited. Hence, even if the guest user acquires authentication information (including the ACT 105), only remote print and PDL print are permitted, and remote copy and remote scan are inhibited.

A concrete example of the contents of the ACT 105 will be explained with reference to FIG. 5C. As shown in FIG. 4, the ACT 105 includes one generated by the SA 102 in response to a request from the MFP 104 upon activation (step S407), and one generated in response to a request from the Drv 103 for a user who is to issue a job (step S413).

In FIG. 5C, a description 521 is an example of information (<UserInfo>) in the ACT 105 generated for a user in step S413. In this example, the user name (UserName) is Taro, and has a role (BaseRole) “PowerUser”. The mail address (UserEmail) is taro@xxx.yyy. This user information may not be contained in the ACT 105 generated in step S407.

A description 522 is an example of the description of functions available with the MFP 104 by a user who is to issue a job. “PdlPrintFlag” is set to “Permit”, and a PDL Print function to print from a PC is available. Function restriction “ColorPrint” in printing is set to “Color” to permit color printing. However, “simplex” is set to “Deny to inhibit simplex printing. The description 522 is also associated with function restriction of the user, and may not be contained in the ACT 105 issued in step S407.

A description 523 is an example of the description of functions available by the MFP 104. In this example, the description 523 describes function restriction on a job having no user authentication <NonAuthentication>. More specifically, “RemoteCopy” and “RemoteScan” are set to “Permit” to permit remote copy and remote scan without any user authentication information. To the contrary, “RemotePrint” is set to “Deny” to restrict remote print by the user.

The description 523 is associated with function restriction of the MFP 104 serving as a device, and may not be contained in the ACT 105 issued in step S413.

An outline of the configuration and operation of the system according to the first embodiment has been described.

The setting process of the ACL 107 by the AU 100 in step S401 of FIG. 4 will be explained in more detail. In the following description, the AU 100 in the server PC 202 in FIG. 2 sets the ACL 107 held in the AD 101 in the directory server 203.

Procedures of the AU 100 to search for a device such as an image processing device (MFP 104) on the network and to create a device group will be described in detail with reference to the flowchart of FIG. 7.

In step S701, the AU 100 starts a device search by transmitting a search request packet by an SLP multicast packet or SNMP broadcast packet to search for devices such as an MFP connected to the network 201. The SLP (Service Location Protocol) is a network protocol defined by IETF RFC2165. This protocol allows searching for services (network address of a node which provides services) on the network.

In this case, the AU 100 designates the service type=printer, and outputs a multicast packet onto the network, thereby searching for a printing apparatus such as an MFP or printer connected to the network 201 including the subnets 206 and 207.

To search for a device incompatible with the SLP, the AU 100 outputs an SNMP packet onto the network. The SNMP (Simple Network Management Protocol) is a network protocol defined by IETF RFC1157 or the like. The use of this protocol and structured data called MIB makes it possible to obtain information on a node on the network. In this case, the AU 100 transmits PrinterMIB (IETF RFC1759) by a broadcast packet to search for a printing apparatus such as an MFP or printer connected to the network 201 including the subnets 206 and 207.

In step S702, the AU 100 receives a search response packet transmitted from a device in response to the search request packet. The search request packet is multicast or broadcast, whereas the search response packet is sent back from each device in a different packet format such as SLP or SNMP. The AU 100 executes step S703 every time it receives not all response packets but a response packet from one device.

In step S703, the AU 100 extracts the network address of the device from the received response packet, and registers it in the device management table 106. The device management table 106 is a data table held in the AU 100. The device management table 106 holds apparatus information such as the network address of a device and its identifier on the network. The device management table 106 further holds information on a group of devices.

In step S704, the AU 100 determines whether a predetermined search response wait time has expired (time-out). The search response wait time can be set to an arbitrary value in accordance with an internal setting in the AU 100 or user designation. If time-out occurs, the AU 100 executes step S705; if no time-out occurs, executes step S702.

In step S705, the AU 100 looks up the device management table 106 to display a list of devices in the table on the CRT display (CRT) 310.

In step S706, the user creates an arbitrary device group using the displayed device list. The user inputs an indication to select image processing devices from the image processing devices in the displayed list, and sets an arbitrary device in the group. The device group can include arbitrary constituent devices, and can also include another device group as a subgroup (or child group) in the group. In other words, devices form a group, and layer attributes can be set to groups.

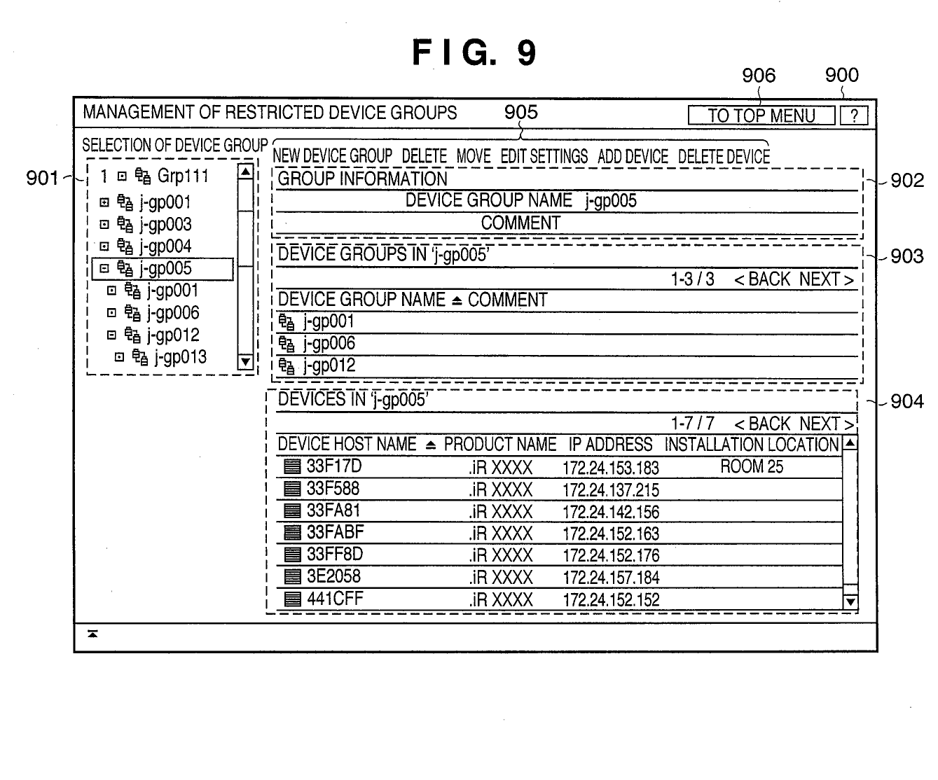

FIG. 9 shows an example of a management window for creating a device group. In FIG. 9, a management window 900 includes a group tree display area 901 displaying the hierarchical structure of created device groups. The management window 900 also includes an area 902 displaying group information on a group selected in the group tree display area 901. The management window 900 also includes an area 903 representing a device group as a subgroup in the selected group. The management window 900 also includes an area 904 representing a list of devices in the selected group.

An operation button group 905 is displayed and includes “new device group”, “delete”, “move”, “edit settings”, “add device”, and “delete device”. A button 906 is used to escape from the management window in FIG. 9 and return to a top menu window.

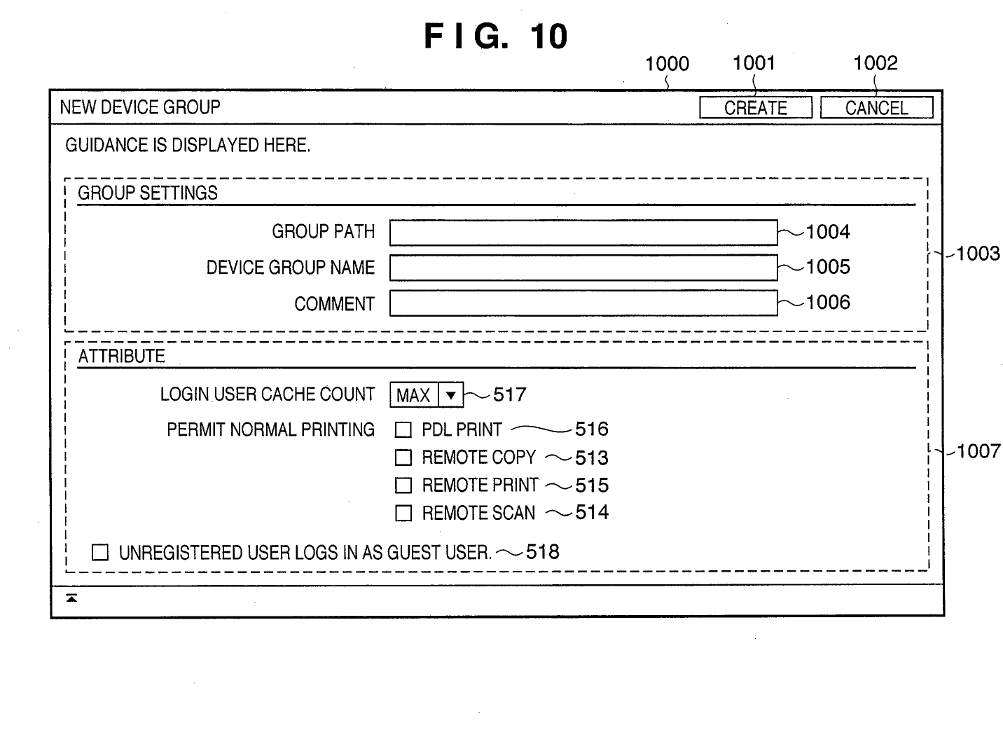

When creating a device group or a device group serving as a subgroup, the user operates “new device group” to add a new device group to the group tree display area 901. At this time, the user can arbitrarily set the layer attribute of the newly added device group via the setup window. The layer attribute may be set at a timing after an arbitrary device is selected from the list 904 for the newly created device group, or at a timing when an image processing device is designated to belong to the device group. As for the new device group, the user can set and register group information in the area 902 by operating the “edit settings” button in the operation button group 905, which will be described with reference to FIG. 10.

A device can be added to or deleted from the group in a window which appears by operating “add device” or “delete device” which allows the user to select a device to be added or deleted. A device can be directly selected and deleted by operating the delete button.

The device management table 106 saves the created device group having a plurality of devices with the attribute of the hierarchical structure. The user may arbitrarily create a device group. Alternatively, each device may be automatically distributed to a predetermined device group using device features (network address, installation location, and the like) obtained by a search.

A process when the AU 100 sets function restriction information of each device or device group in the ACL 107 using the created device management table 106 will be explained in more detail with reference to the flowchart of FIG. 8.

In step S801, the AU 100 looks up the device management table 106 to acquire information on devices and device groups and display device groups using a hierarchical tree structure. A display example of device groups is the same as that shown in FIG. 9. In step S802, the AU 100 accepts, from the user, a selection of an arbitrary device group in the tree display area 901. Since a device group is selected from the tree display area 901, the layer attribute in the group is automatically determined upon selecting any device group. Device groups on lower layers are also automatically or semiautomatically set as operation targets.

In step S803, the AU 100 displays detailed information of the selection-accepted device group in the window 900. In FIG. 9, the area 902 displays group information of the selected device group. The area 903 displays subgroups in the selected device group. The area 904 displays a list of devices in the selected device group.

In step S804, the AU 100 determines whether it has accepted an indication to set function restriction information for the device group selected in the tree display area 901. This determination is based on whether the user operates “edit settings” in the operation button group 905 in the window 900.

If the user actually operates the button “edit settings” and the AU 100 determines that it has accepted the setting indication (“YES” in step S804), the process shifts to step S805. If the AU 100 determines that it has not accepted the indication (“NO” in step S804), the process shifts to step S809.

In step S805, the AU 100 displays a function restriction information setup/editing window on the CRT display (CRT) 310 for the device group. FIG. 10 shows an example of this display window.

FIG. 10 shows a setup window for indicating function restriction settings of an image processing device. For a group selected from the area 901 in FIG. 9, settings of function restriction information on functions restricted in use in executing a job are accepted via the setup window in FIG. 10.

In FIG. 10, a window 1000 displays a group setting area 1003 and attribute setting area 1007. A group path 1004, device group name 1005, and comment 1006 can be input to the group setting area 1003.

The login user cache count 517 can be set in the attribute setting area 1007 in correspondence with function restriction information shown in FIG. 5B. The remote copy 513, remote scan 514, remote print 515, and PDL print 516 can be set. To permit the use of a function on a corresponding item, the check field is checked. To inhibit the use of a function, the check field remains unchecked. The guest login 518 can also similarly be set.

Upon completion of input to the group setting area 1003 and attribute setting area 1007, the user can finalize and register input contents by operating a creation button 1001. The user can cancel contents and return to the window in FIG. 9 by operating a cancel button 1002.

In step S806, the AU 100 determines whether the user has made settings by operating the creation button 1001 in the window of FIG. 10. If the user has made settings (“YES” in step S806), the process shifts to step S807. If the user operates the cancel button 1002 (“NO” in step S806), the process shifts to step S809.

In step S807, the AU 100 searches for nodes belonging to the device group selected in the tree display area 901. If the AU 100 detects image processing devices as nodes (“device detected” in step S807), it updates the device settings of all the detected devices in step S808. That is, the contents of the ACL 510 shown in FIG. 5B for the image processing devices are updated to contents set in FIG. 10.

If the AU 100 detects device groups (subgroups having a layer attribute lower than that of the selected group) as nodes (“group detected” in step S807), it recursively executes step S807 for all the detected groups. That is, step S807 is repetitively executed until no group having a lower layer attribute is detected in the device group selected first in the area 901 (“no node” in step S807). As a result, step S808 is executed for all devices belonging to groups following the tree of the first designated group. If no node is detected in the group, the AU 100 executes step S809.

For example, a group selected in the tree display area 901 in FIG. 9 contains seven devices in the group and three lower groups. Step S808 is executed for each of the seven devices, and setting contents in FIG. 10 are reflected in the ACL 510 of each device. For each of the three lower groups, step S807 is executed to search for devices, and function restriction information of each detected device is updated.

In step S809, the AU 100 determines whether to complete the operation to the device group. This process is based on, for example, whether the user has operated the button 906 in the window of FIG. 9. If the operation is complete, the process ends. If the operation is not complete, the process returns to step S801 and continues.

As described above, according to the first embodiment, the system administrator of a network device or the like can efficiently set not only function restriction of each user but also function restriction of each device group or the like at once.

The system which concentratedly manages function restriction information can manage target devices as a device group on the network, and set function restriction information for each group. In setting, target groups are displayed in a hierarchical tree structure, and the system administrator suffices to set only the top group. The settings are automatically reflected in subgroups and all devices in the group. This obviates the need to select and set devices and subgroups one by one, implementing more efficient batch setting.

The user can make user-independent settings for each device by a simple operation in an easy-to-see window display.

### Second Embodiment

The second embodiment of the present invention will be explained. The first embodiment can set user-independent function restriction information by holding information as shown in FIG. 5C as the ACT 105 of each device in the ACL 107.

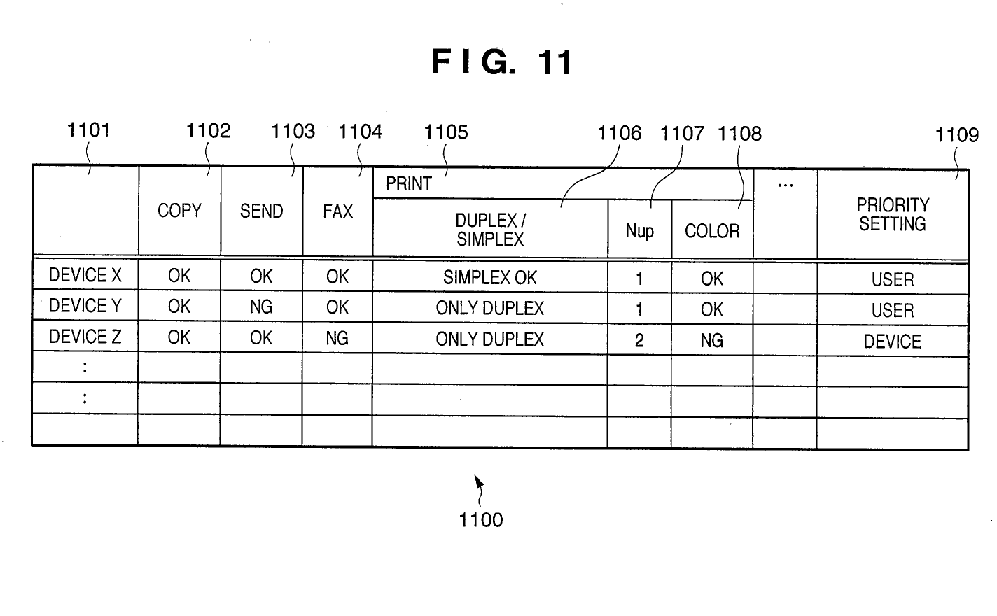

In contrast, the second embodiment is characterized in setting the function restriction items of the ACT of each device equivalent to those of the ACT of each user. FIG. 11 shows an example of an ACL containing function restriction of each device. In addition to the function restriction items, it can be set which of function restriction of each user and that of each device is prioritized. An AU 100 sets information corresponding to the ACL in a device group function restriction setup/editing window.

In FIG. 11, an ACL 1100 registers a device name 1101. The device name has the same contents as those of the device name 511 in FIG. 5B, and information for identifying each device is registered. Copy 1102, send 1103, FAX 1104, print 1105, duplex/simplex 1106, Nup 1107, and color 1108 correspond to items of the same names in FIG. 5A.

Priority setting 1109 sets whether to restrict the functions of a device based on an ACT 105 created for each user or restrict the functions based on an ACT 105 created for each device based on the ACL 1100.

For example, as for device X, the priority setting 1109 exhibits “user”, and device X receives a job execution request from the user. In this case, whether to restrict each function such as copying is determined based on the contents of authentication information 602 (corresponding to the contents of the ACT 105 of the user) attached to a job. As for device Z, the priority setting 1109 exhibits “device”. When device Z accepts a job execution request, whether to restrict each function is determined based on the ACT 105 created for device Z regardless of the contents of the authentication information 602 attached to a job. That is, no user can utilize the FAX function and color print function of device Z.

If the priority setting 1109 of a job-requested device exhibits “device” when the SA 102 issues the ACT 105 for a user who requests a job, the ACT 105 of the user may be issued based on the contents of the ACL 1100. If the priority setting 1109 of a job-requested device exhibits “user”, the ACT 105 of the user may be issued based on the contents of the ACL 500. In this manner, function restriction information can be properly used depending on the contents of the priority setting 1109. When the ACT 105 is issued, the device determines whether to execute a job, based on the contents of the authentication information 602 attached to the job.

For a user who cannot issue a job containing the authentication information 602, function restriction may be imposed based on the ACL 510 of each device as shown in FIG. 5B or the ACL 1100. In this case, the user cannot issue the ACT 105 for a device whose priority setting 1109 exhibits “user”, and function restriction can be imposed in accordance with the ACT 105 issued for the device.

As described above, the second embodiment can set which of function restriction set for each device and that set for each user is prioritized. The second embodiment can achieve highly flexible function restriction depending on user convenience.

The second embodiment can reduce the cost of setting function restriction by the administrator of the network system even in a large-scale network environment where the numbers of devices and users are enormous.

### Third Embodiment

In the first and second embodiments, the ACL 107 is configured for each user or device, as shown in FIG. 5A, 5B, or 11.

The ACL can also be configured for each user group or device group. In this case, user information 110 of an AD 101 or an ACL 107 can hold configuration information of users and user groups or that of devices and device groups. An AU 100 can set function restriction information of a user group or device group in the ACL 107.

According to the third embodiment, for example, when user A requests a job of device X, an SA 102 searches for the user information 110 or ACL 107 to determine a user group to which user A belongs and a device group to which device X belongs. The SA 102 acquires function restriction information of each group based on this determination. The SA 102 can issue an ACT 105 based on the acquired function restriction information.

The third embodiment can more efficiently set the ACL 107 by dealing with users and devices for each group.

### Fourth Embodiment

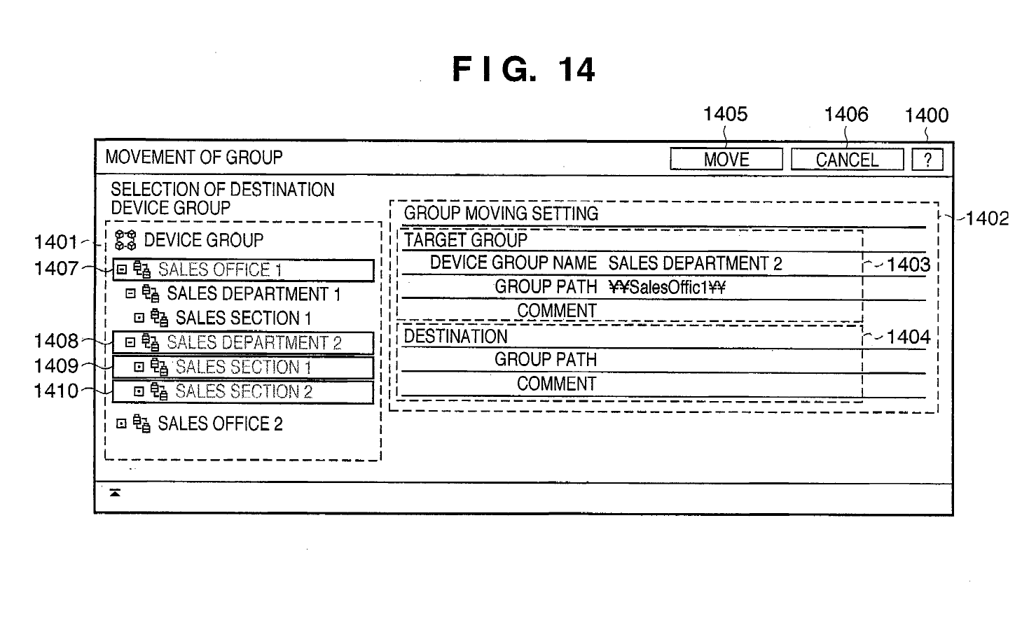

The fourth embodiment will be described. FIG. 14 shows an example of a process according to the fourth embodiment.

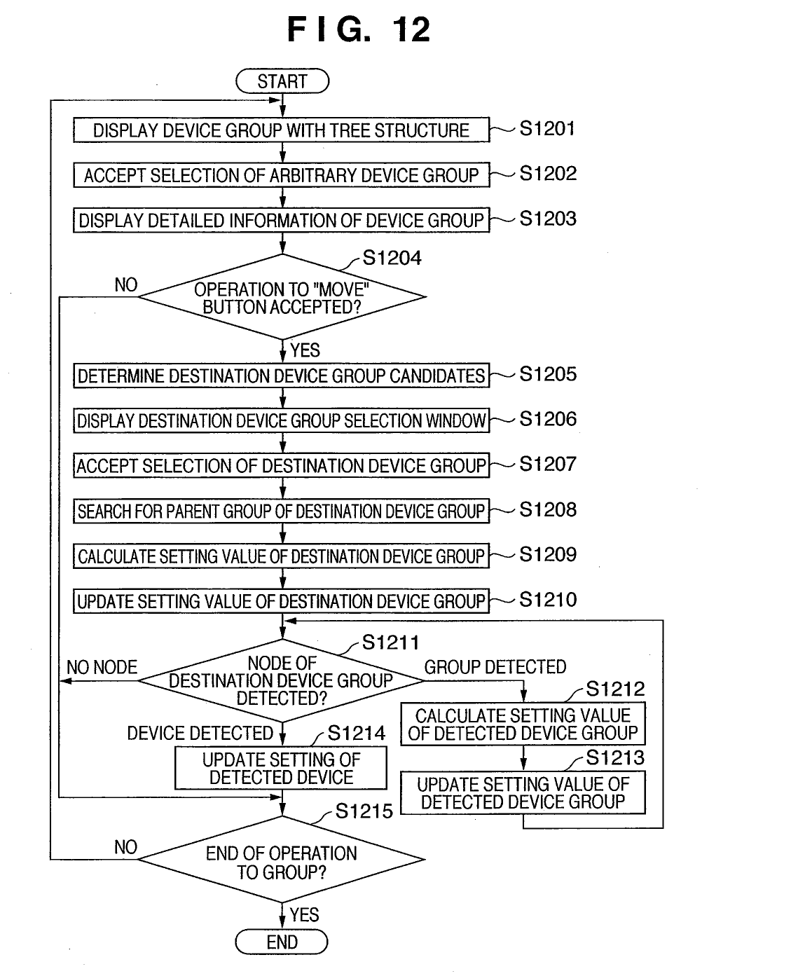

A process when an AU 100 moves a device group in a device management table 106 described in any of the above-described embodiments will be explained with reference to the flowchart of FIG. 12.

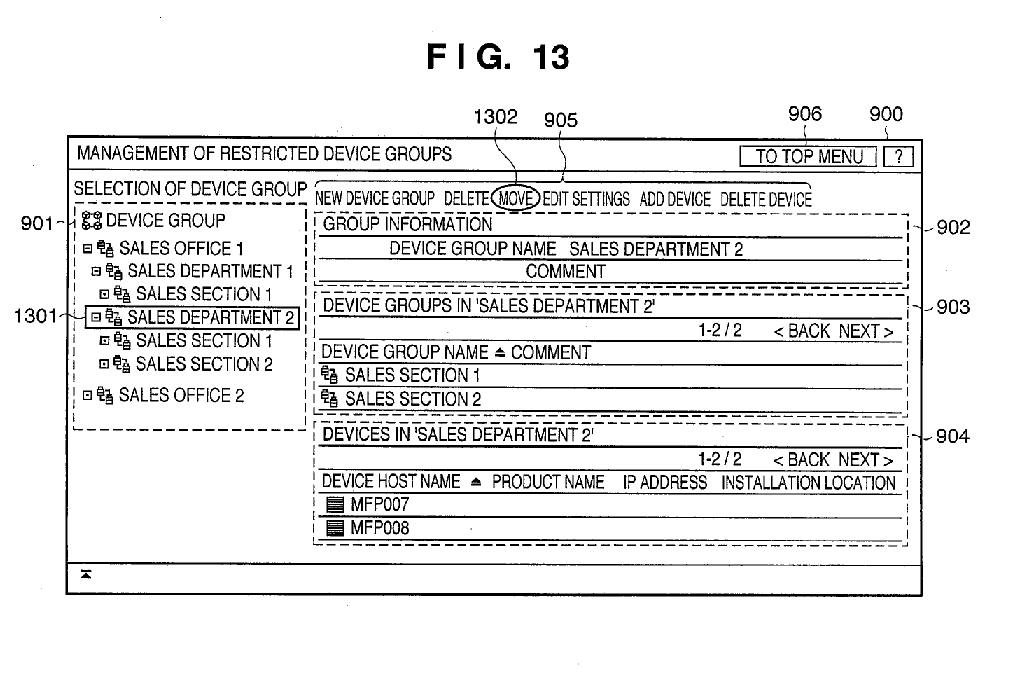

In step S1201, the AU 100 looks up the device management table 106 to acquire information on devices and device groups and display device groups with a hierarchical tree structure. FIG. 13 shows a display example of device groups.

FIG. 13 shows an example of a management window according to the fourth embodiment. The basic display form is the same as that shown in FIG. 9. More specifically, a management window 900 includes a group tree display area 901 displaying the hierarchical structure of device groups. The management window 900 also includes an area 902 displaying group information on a group selected in the group tree display area 901. The management window 900 also includes an area 903 representing a device group as a subgroup in the selected group. The management window 900 also includes an area 904 representing a list of devices in the selected group. The management window 900 displays an operation button group 905 and button 906. The user can open a device group moving window by operating a move button 1302. Display contents in each area are different from those in FIG. 9 in order to explain the process of the fourth embodiment.

In step S1202, the AU 100 accepts, from the user, selection of an arbitrary device group on any layer at the tree displayed in the area 901. In FIG. 13, “Sales Department 2” 1301 immediately before “Sales Office 1” is selected. In step S1203, the AU 100 displays detailed information of the selection-accepted device group in the areas 902 to 904. In FIG. 13, the “Sales Department 2” 1301 is selected.

In step S1204, the AU 100 determines whether it has accepted an operation to the move button 1302 in the operation button group 905. If the AU 100 has accepted an operation to the move button 1302 (“YES” in step S1204), the process shifts to step S1205. If the AU 100 has not accepted any operation to the move button 1302 (“NO” in step S1204), the process shifts to step S1215.

In step S1205, the AU 100 decides device groups serving as destination candidates to which the device group selected in step S1202 can be moved. For example, decision conditions can be set as follows. Condition decision expressions associated with these settings are stored in advance in a storage area available by the AU 100.

Condition 1) A target group cannot be moved when the target group is identical to a destination group.

Condition 2) A target group cannot be moved to a parent group immediately above the target group.

Condition 3) A target group cannot be moved to a child group of the target group.

Condition 4) A target group cannot be moved when a group of the same name exists in a destination group.

Based on these decision conditions, destination candidates are decided.

In step S1206, the AU 100 displays decided destination candidate device groups in a window as shown in FIG. 14. FIG. 14 shows an example of a group moving window. A window 1400.displays a destination device group selection area 1401 on the left side. A setting area 1402 for moving a group includes an area 1403 displaying information on a group to be moved, and an area 1404 displaying information on a destination group.

In the fourth embodiment, the area 1403 represents that “Sales Department 2” immediately below “Sales Office 1” is selected as a group to be moved. In the device group selection area 1401, “Sales Department 2” is excluded from destination candidates under condition 1). “Sales Office 1” immediately above “Sales Department 2” is excluded from destination candidates under condition 2). “Sales Section 1” and “Sales Section 2” are child groups of “Sales Department 2”, and thus are excluded from destination candidates under condition 3). Device groups 1407 to 1410 excluded from candidates in this way are grayed out.

A display method other than grayout display can be employed as long as the user can recognize that a device group is excluded from destination candidates. As described above, when selection of a device group is accepted, the main processor functioning as an identification means can identify a group which is improper as a destination, and can display the identification result on the display unit.

The user operates a move button 1405 to move a target group to a destination group after setting them. The user operates a cancel button 1406 to cancel setting contents and return to the window in FIG. 13.

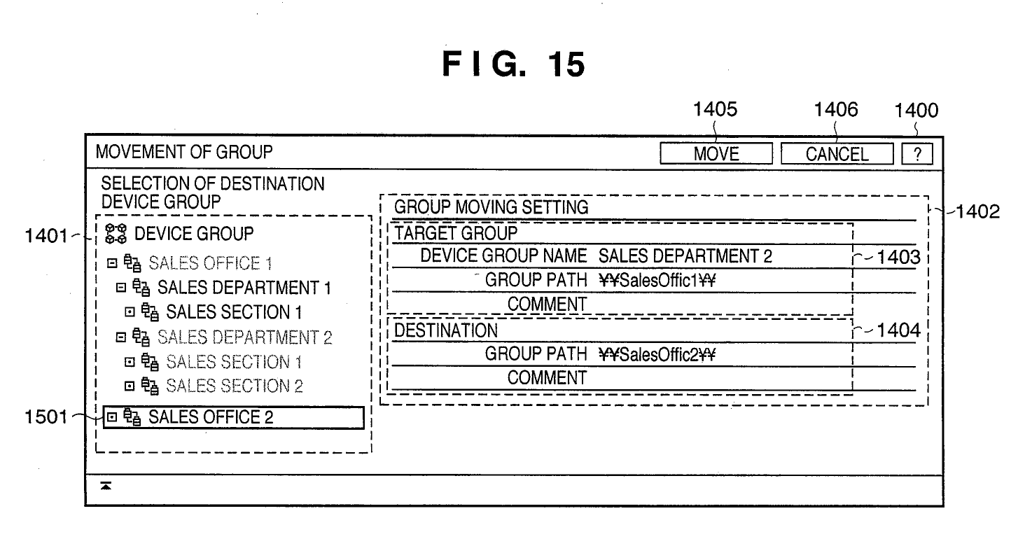

In step S1207, the AU 100 accepts selection of a destination device group in the destination device group selection area 1401. The destination device group has a different layer attribute. After accepting the selection, the area 1404 displays information on the selected destination device group. FIG. 15 shows an example of this display. In the area 1401, “Sales Office 2” is selected to show a selection mark 1501. The area 1404 displays “group path ¥¥SalesOffice2¥¥” to reveal that “Sales Office 2” is selected as a destination.

Groups excluded from destination candidates are not grayed out in the display example of FIG. 15, but are grayed out in practice. The display unit identifiably displays destination candidate groups, groups excluded from destination candidates, and groups on a layer selected as a destination.

If the user selects the move button 1405 in this display, the AU 100 searches for all upper device groups in the tree structure of the destination device group in step S1208. In step S1209, the AU 100 reads out the settings of the upper device groups including the destination device group based on layer attributes stored in the device management table 106, and calculates the setting value (function restriction information) of the destination device group.

Conceivable Calculation Methods are:

The same setting value as that of the top device group is set.

The same setting value as that of a device group immediately above the destination device group is set.

The AND value of the setting values of all device groups is set.

The OR value of the setting values of all device groups is set.

The setting value is calculated based on preset rule.

However, the calculation method is not particularly limited. The user may select any calculation method. In step S1210, the AU 100 calculates the setting value of the destination device group and updates the setting value to the calculated one.

The AU 100 searches for a node belonging to the selected destination device group (S1211). If a group is detected in node search (“group detected” in step S1211), the AU 100 calculates the setting value of the node (device group) from the setting values of the destination device group and detected device group in step S1212. This calculation method is the same as that in step S1209. In step S1213, the AU 100 updates the setting value. If a device is detected in node search (“device detected” in step S1211), the process shifts to step S1214. In step S1214, the AU 100 updates function restriction information of the detected device in an ACL 107. The AU 100 recursively executes the process from steps S1211 to S1214 to update the setting values (function restriction information) of all nodes belonging to the destination device group. The process according to the flowchart of FIG. 12 updates the storage contents of the device management table 106.

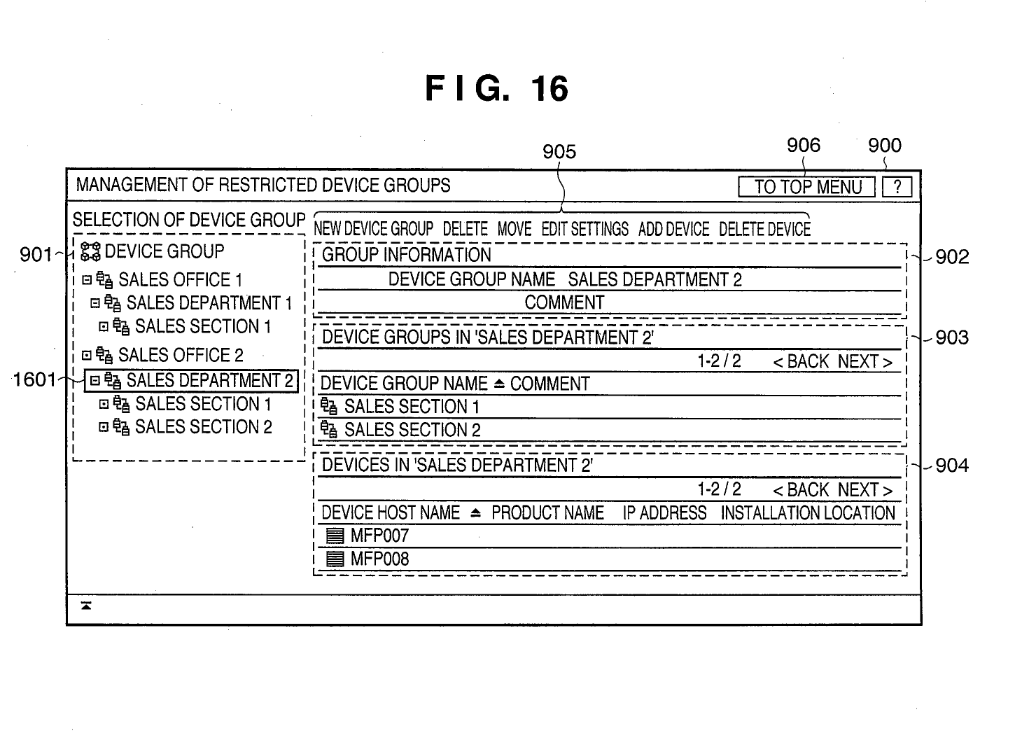

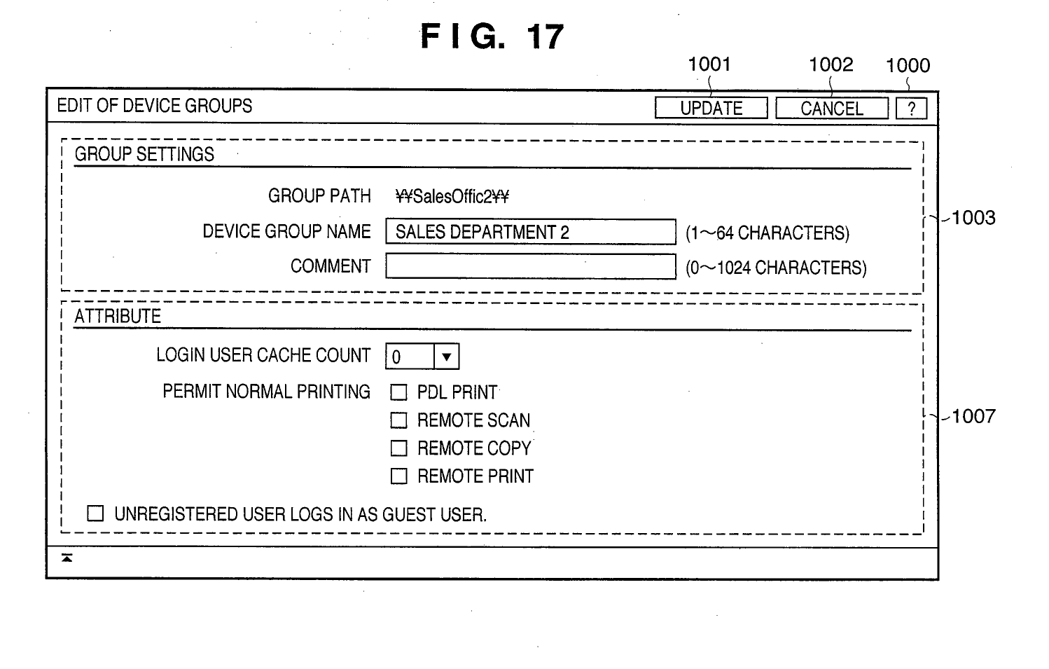

After the end of the update process, the management window 900 displays the tree of device groups after executing the device group moving process. FIG. 16 shows an example of this display. In FIG. 16, “Sales Department 2” 1601 including “Sales Section 1” and “Sales Section 2” is moved immediately below “Sales Office 2” in the area 901. When updating and changing function restriction information of a device group with reference to this display, the user can open a window as shown in FIG. 17 by operating the button “edit settings”. In FIG. 17, function restriction can be updated in the attribute setting area 1007 in the window of FIG. 10. The user can finalize updated setting contents by operating an update button 1701.

When moving another group (“NO” in step S1215), the process returns to step S1201 and continues. If no other group is moved (“YES” in step S1215), the process ends.

In the above example, the AU 100 updates the setting values (device function restriction information and ACL) of a device group and devices in moving the device group. Instead, an SA 102 may update the setting values.

When the AU 100 performs the device group moving process, only each device group recorded in the device management table 106 may be updated without updating function restriction information of each device in the ACL 107. In this case, when issuing an ACT 105, the SA 102 calculates it based on the device management table 106 and function restriction information of other devices and device groups. This process also yields the same effects as those obtained by updating the ACL 107.

In the system, the setting value of each device group or device is calculated at an arbitrary timing and an arbitrary location as long as the same ACT can be issued finally.

As described above, the fourth embodiment can group devices and move the group. The fourth embodiment can achieve an efficient process by reflecting the setting contents of a group on an upper layer in function restriction information after movement without setting the function restriction information for each group or device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-113749, filed Apr. 17, 2006, which is hereby incorporated by reference herein in its entirety.

What is claimed is:

1. A management system connected via a network to a plurality of image processing devices and a client apparatus, comprising:
a storage unit adapted to store management information for grouping the plurality of image processing devices and managing the plurality of image processing devices as a device group having a layer attribute;
a display controller adapted to layer a plurality of device groups based on the management information and causes a display unit to display the layered device groups;
a selection unit adapted to select a device group from the layered device groups displayed on the display unit;
a setting acceptance unit adapted to accept, for the device group selected by said selection unit, setting of function restriction information on a function restricted in use in executing a job; and
a setting unit which sets the function restriction information for all image processing devices in the set device group,
wherein said setting unit sets, for a group of image processing devices on a lower layer of the selected device group, the function restriction information set by said setting unit.

2. A management system which has an authentication unit adapted to perform authentication for a request from an external apparatus, and a response unit adapted to send back a response associated with function restriction in job execution to an authentication requesting side based on the authentication by the authentication unit, and which can communicate with a plurality of image processing devices, comprising:
a grouping unit adapted to set a group of image processing devices;
a setting indication unit adapted to indicate function restriction setting of an image processing device; and
a setting unit which makes the function restriction setting indicated by said setting indication unit at once for the image processing devices grouped by said grouping unit,
wherein when one of the grouped image processing devices issues the request, the response unit sends back a response associated with function restriction with reference to contents set by the setting unit.

3. The system according to claim 2, wherein said grouping unit sets a layer attribute for the group of image processing devices.

4. The system according to claim 3, wherein said setting unit makes the function restriction setting at once for image processing devices in a group on a lower layer of a selected group.

5. The system according to claim 3, further comprising:
a selection acceptance unit adapted to accept selection of one of groups; and
a moving indication acceptance unit adapted to accept an indication to move the selection-accepted group to a group having another layer attribute,
wherein said setting unit makes setting based on the function restriction setting of a destination group for image processing devices in the moving indication-accepted group.

6. The system according to claim 5, further comprising:
an identification unit adapted to identify a group that is improper as a destination when said selection acceptance unit accepts selection of a group; and
a display controller adapted to identifiably display the group identified by said identification unit.

7. The system according to claim 3, wherein a plurality of groups are displayed in a tree structure based on the layer attribute.

8. The system according to claim 2, wherein
the authentication unit authenticates a user,
the response unit sends back a response associated with function restriction corresponding to the user to be authenticated with reference to function restriction setting of the user, and
the management system further comprising:
a priority setting unit adapted to set, for the group of devices, which of function restriction setting of a user-independent applicable device and function restriction setting of each user is prioritized; and
a use selection unit adapted to selectively use one of the function restriction setting of the user-independent applicable device and the function restriction setting of each user based on setting by said priority setting unit when executing a job from a user.

9. The system according to claim 2, wherein said setting unit sets restriction on login of a guest user to an image processing device.

10. The system according to claim 2, wherein said setting unit sets permission/inhibition of remote copy or permission/inhibition of remote scan as function restriction setting.

11. The system according to claim 2, wherein an external apparatus is an image processing device, and a request from the image processing device is issued at a timing when the image processing device is activated or when an indication is input via an operation unit of the image processing device.

12. A management system comprising:
a grouping unit adapted to set a group of image processing devices;
a setting indication unit adapted to indicate function restriction setting associated with a function of an image processing device that is restricted in use in executing a job by the image processing device; and
a setting unit adapted to make the function restriction setting indicated by said setting indication unit at once for the image processing devices grouped by said grouping unit.

13. A method of controlling a management system which is connected via a network to a plurality of image processing devices and a client apparatus, and has a storage unit adapted to store management information for grouping the plurality of image processing devices and managing the plurality of image processing devices as a device group having a layer attribute, comprising:
a display control step of layering a plurality of device groups based on the management information and causing a display unit to display the layered device groups;
a selection step of selecting a device group from the layered device groups displayed on the display unit;
a setting accepting step of accepting, for the device group selected in the selection step, setting of function restriction information on a function restricted in use in executing a job; and
a setting step of setting the function restriction information for all image processing devices in the set device group,
wherein in the setting step, the set function restriction information is set for a group of image processing devices on a lower layer of the selected device group.

14. A method of controlling a management system which has an authentication unit adapted to perform authentication for a request from an external apparatus, and a response unit adapted to send back a response associated with function restriction in job execution to an authentication requesting side based on the authentication by the authentication unit, and which can communicate with a plurality of image processing devices, comprising:
a grouping step of setting a group of image processing devices;
a setting indication step of indicating function restriction setting of an image processing device;
a setting step of making the function restriction setting indicated in the setting indication step at once for the image processing devices grouped in the grouping step; and
a response step of causing the response unit to send back a response associated with function restriction with reference to contents set in the setting step when one of the grouped image processing devices issues the request.

15. The method according to claim 14, wherein in the grouping step, a layer attribute is set for the group of image processing devices.

16. The method according to claim 15, wherein in the setting step, the function restriction setting is made at once for image processing devices in a group on a lower layer of a selected group.

17. The method according to claim 15, further comprising:
a selection accepting step of accepting selection of one of groups; and
a moving indication accepting step of accepting an indication to move the selection-accepted group to a group having another layer attribute,
wherein in the setting step, setting based on the function restriction setting of a destination group is made for image processing devices in the moving indication-accepted group.

18. The method according to claim 17, further comprising:
an identification step of identifying a group that is improper as a destination when selection of a group is accepted in the selection accepting step; and
a display control step of identifiably displaying the group identified in the identification step.

19. The method according to claim 15, wherein a plurality of groups are displayed in a tree structure based on the layer attribute.

20. The method according to claim 14, further comprising:
an authentication step of authenticating a user by the authentication unit;
a step of causing the response unit to send back a response associated with function restriction corresponding to the user to be authenticated with reference to function restriction setting of the user;
a priority setting step of setting, for the group of devices, which of function restriction setting of a user-independent applicable device and function restriction setting of each user is prioritized; and
a use selection step of selectively using one of the function restriction setting of the user-independent applicable device and the function restriction setting of each user based on setting in the priority setting step when executing a job from a user.

21. The method according to claim 14, wherein in the setting step, restriction on login of a guest user to an image processing device is set.

22. The method according to claim 14, wherein in the setting step, permission/inhibition of remote copy or permission/inhibition of remote scan is set as function restriction setting.

23. The method according to claim 14, wherein an external apparatus is an image processing device, and a request from the image processing device is issued at a timing when the image processing device is activated or when an indication is input via an operation unit of the image processing device.

24. A method of controlling a management system, comprising:
a grouping step of setting a group of image processing devices;
a setting indication step of indicating function restriction setting associated with a function of an image processing device that is restricted in use in executing a job by the image processing device; and
a setting step of making the function restriction setting indicated in the setting indication step at once for the image processing devices grouped in the grouping step.

25. A computer program which is stored in a computer-readable storage medium and causes a computer to execute a method of controlling a management system which is connected via a network to a plurality of image processing devices and a client apparatus, and has a storage unit adapted to store management information for grouping the plurality of image processing devices and managing the plurality of image processing devices as a device group having a layer attribute, the method comprising:
a display control step of layering a plurality of device groups based on the management information and causing a display unit to display the layered device groups;
a selection step of selecting a device group from the layered device groups displayed on the display unit;
a setting accepting step of accepting, for the device group selected in the selection step, setting of function restriction information on a function restricted in use in executing a job; and
a setting step of setting the function restriction information for all image processing devices in the set device group,
wherein in the setting step, the set function restriction information is set for a group of image processing devices on a lower layer of the selected device group.

26. A computer program which is stored in a computer-readable storage medium and causes a computer to execute a method of controlling a management system which has an authentication unit adapted to perform authentication for a request from an external apparatus, and a response unit adapted to send back a response associated with function restriction in job execution to an authentication requesting side based on the authentication by the authentication unit, and which can communicate with a plurality of image processing devices, the method comprising:
a grouping step of setting a group of image processing devices;
a setting indication step of indicating function restriction setting of an image processing device;
a setting step of making the function restriction setting indicated in the setting indication step at once for the image processing devices grouped in the grouping step; and
a response step of causing the response unit to send back a response associated with function restriction with reference to contents set in the setting step when one of the grouped image processing devices issues the request.

27. A computer program which is stored in a computer-readable storage medium and causes a computer to execute a method of controlling a management system, the method comprising:
a grouping step of setting a group of image processing devices;
a setting indication step of indicating function restriction setting associated with a function of an image processing device that is restricted in use in executing a job by the image processing device; and
a setting step of making the function restriction setting indicated in the setting indication step at once for the image processing devices grouped in the grouping step.
